(19) United States
(12) Patent Application Publication
(10) Pub. No.: US 2013/0246790 A1
(43) Pub. Date: Sep. 19, 2013

(54) STORAGE METHOD, SYSTEM AND APPARATUS

(71) Applicant: Donglin Wang, Beijing (CN)

(72) Inventor: Donglin Wang, Beijing (CN)

(73) Assignee: TIANJIN SURSEN INVESTMENT CO., LTD., Airport Economic Area,Tianjian (CN)

(21) Appl. No.: 13/642,514

(22) PCT Filed: May 12, 2012
(86) PCT No.: PCT/CN12/75793

§ 371 Date: Jan. 17, 2013

(30) Foreign Application Priority Data
Mar. 19, 2012 (CN) 201210073799.8

(51) Int. Cl. H04L 9/08

(52) U.S. Cl. CPC H04L 9/08
USPC 713/168

(57) ABSTRACT

The present invention discloses a storage method, system and apparatus. The method comprises: encrypting data with a storage key to obtain encrypted data; encrypting the storage key with two different encryption methods to generate a personal key and a data key, respectively, wherein the personal key can be decrypted with a key from the user who owns the data to obtain the storage key, and the data key can be decrypted with the unencrypted data to obtain the storage key; saving the encrypted data, personal key and data key in a server. The technical scheme of the present invention can prevent saving duplicate files while ensuring that the unencrypted data cannot be accessed by any other users and storage service providers.

### CROSS-REFERENCE TO RELATED APPLICATION

The application is a continuation in part of PCT/CN2012/075793 (filed on May 21, 2012), which claims priority of Chinese patent application 201210073799.8 (filed on Mar. 19, 2012), the contents of which are incorporated herein by reference.

### FIELD OF THE INVENTION

The present invention relates to storage technology, and particularly, to a storage method, system and apparatus.

### BACKGROUND OF THE INVENTION

Cloud storage (includes public cloud and private cloud) has been more and more of a trend. Cloud storage indicates a system that collects massive amounts of different storage devices on the Internet and makes them work together by using application software with functions such as cluster application, grid technology, or distributed file systems, for the purpose of offering data storage and business access services.

To a cloud storage service provider, when massive amounts of users are uploading massive amounts of data, the uploading of duplicate files will not be actually accepted in order to optimize the utility of the storage space. For example, when User 1 has stored a File B, if another file to be uploaded by User 2 to the storage is found to be the same File B in the scan before the uploading, the file from User 2 will not be actually uploaded and the existing File B will be simply added into User 2's account.

In the prior art, in order to ensure that the second user can access the file normally when the same file is added into the second user's account, the common practice is encrypting the file with a symmetric key and saving the key in the server for long-term use. If asymmetric keys are used for the encryption, the service provider must have knowledge of the personal key or the service provider will not be able to give the access authorization of the file to the second user. That is, since the cloud storage service provider needs to authorize the second user (which has the same file) to access the file, the service provider must be able to recognize the file (recognize the unencrypted file or possess the decryption key to the file), hence technically the service provider (and its staff) is able to access the unencrypted contents saved by users and ethics are the only thing restricting the service provider. For example, the staff of Dropbox, which states that files stored on it are safe, are able to view the contents of the files saved by users (even when the files are stored in encrypted mode, because the service provider has the knowledge of the encryption rules and decryption keys so as to provide the files to other users).

In view of the above, a new technology is needed to prevent saving duplicate files while ensuring that unencrypted data cannot be accessed by other users even cloud storage service providers.

### SUMMARY OF THE INVENTION

In view of the above, the present invention provides a storage method, system and apparatus to prevent saving duplicate files while ensuring that file cannot be accessed as unencrypted data by other users even the cloud storage service providers.

A storage method, comprising:

encrypting a data file with an storage key to obtain encrypted data file;

encrypting the storage key with two different encryption methods to generate a personal key and a data key respectively, wherein the personal key can be decrypted with a key from the user who owns the data file to obtain the storage key, and the data key can be decrypted with the unencrypted data file to obtain the storage key;

saving the encrypted data file, personal key and data key in a server;

wherein, when data file to be uploaded from a user is same with a data file stored in the server, the method further comprises:

decrypting the data key with the unencrypted data file to be uploaded to obtain the storage key;

encrypting the storage key with a key from the user to generate the personal key of the user;

saving the personal key of the user.

By using the technical scheme of the present invention, duplicate data will not be stored repeatedly, each data is encrypted and only the user that owns the same data will be authorized to access the storage key. Since the storage key is further encrypted with two different encryption methods to generate a personal key and a data key respectively, the third party that actually owns the same data can use the data itself to decrypt the data key to obtain the storage key and then encrypt the storage key again with an encryption key of the third party to generate a personal key of the third party, so as to access the data with the personal key in the future. The whole procedure ensures that only the party that actually owns the same data will be authorized to access the storage key and the storage service provider will have no way to access the unencrypted data or storage key throughout the entire procedure.

### BRIEF DESCRIPTION OF THE DRAWINGS

FIG. 1 is a flow chart of a storage method provided in the embodiment of the present invention;

FIG. 2 is another flow chart of a storage method provided in the embodiment of the present invention;

FIG. 3 is yet another flow chart of a storage method provided in the embodiment of the present invention;

FIG. 4 is a schematic diagram illustrating the structure of the storage system provided in the embodiment of the present invention;

FIG. 5 is another schematic diagram illustrating the structure of the storage system provided in the embodiment of the present invention.

### DETAILED DESCRIPTION OF THE INVENTION

The present invention is further described in detail hereinafter with reference to the accompanying drawings as well as embodiments so as to make the objective, technical scheme and merits thereof more apparent.

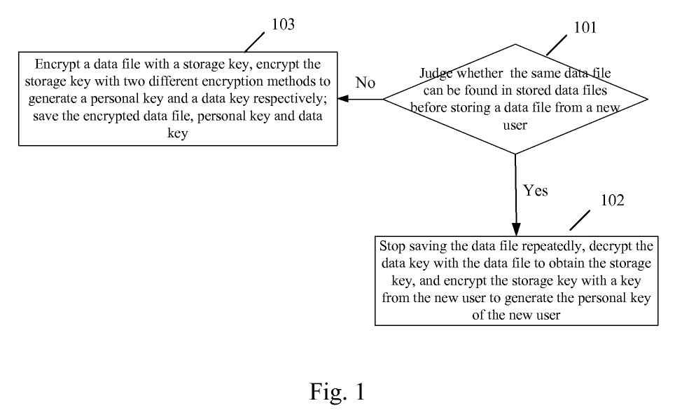

FIG. 1 is a flow chart of a storage method provided in the embodiment of the present invention. In this embodiment, data is stored after being encrypted with a storage key; and the storage key is further encrypted with two different encryption methods to generate a personal key and a data key respectively, wherein the personal key can be decrypted by a key of a user who owns the data to obtain the storage key and the data key can be decrypted by the unencrypted data to obtain the storage key; finally, the encrypted data, personal key and data key are saved. The method detailed comprises:

Step 101: before storing a data from a user, judge whether any of stored data is same with the data to be uploaded; if yes, execute Step 102; otherwise execute Step 103;

Step 102: Do not upload and save another copy of the data from the user, decrypt the data key of the same data with the unencrypted data to be uploaded to obtain the storage key, and encrypt the storage key with a key of the user to generate the personal key of the user; save the personal key of the user, and then terminate the process.

Step 103: encrypt the data with a storage key, encrypt the storage key with two different encryption methods to generate a personal key and a data key respectively, and the methods are same as disclosed above; save the encrypted data, personal key and data key; then terminate the process.

When accessing the data in the future, the user uses his/her own key to decrypt the personal key and obtain the storage key, and then obtain the unencrypted contents of the data by using the storage key. In this way, storing duplicate data in the server can be prevented and also the storage service provider itself (its staff) is unable to access the unencrypted content of the data.

In another embodiment of the present invention, the server judges duplicate data based on the HASH values of the data, for example, two files will be regarded as the duplicate of each other if the two files have the same HASH values. Therefore the HASH values of all data will be saved in the server side and the HASH value of data to be stored will be calculated before the file is stored so that the server can judge whether a duplicate of the data already exists. Obviously those skilled in the art may use other methods to judge whether files are duplicates and the present invention does not limit the judgment method.

In another embodiment of the present invention, there is a client on the user side; when the server side judges that there already exists duplicate data in the server, the data key of the data on the server will be sent to the client side; the client side decrypts the data key received with the unencrypted data at its own side to obtain the storage key; the client side also uses a key of the user to encrypt the storage key to generate the personal key of the user and sends the personal key of the new user to the server for storage.

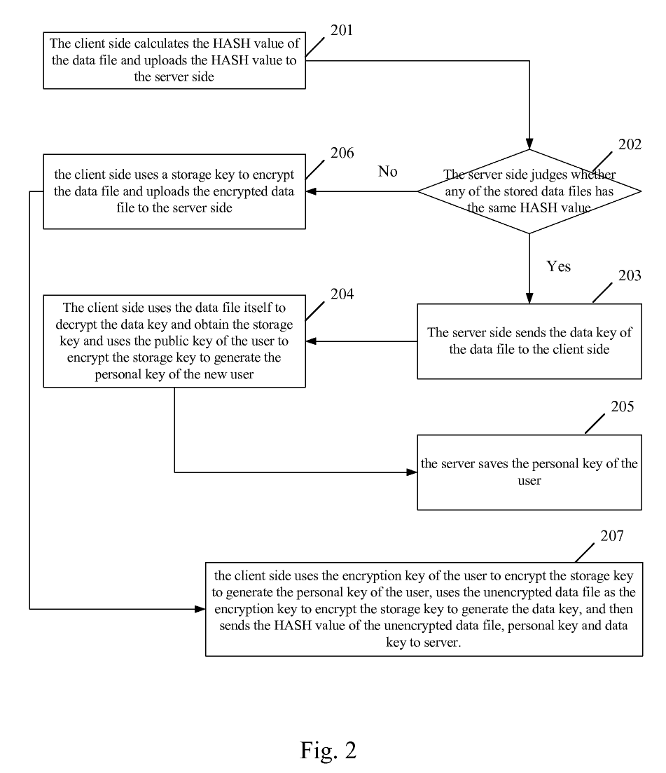

FIG. 2 shows a practical example of the embodiment.

FIG. 2 shows a storage method provided in the embodiment of the present invention. In this embodiment, HASH values are utilized to recognize duplicate files; a user's encryption key is used to encrypt the storage key to obtain a personal key for the user, a corresponding decryption key of the user is used to decrypt the personal key to obtain the storage key; wherein, the user's encryption key may be the public key of the user, and corresponding decryption key of the user may be the private key of the user. Meanwhile, a data key is obtained through symmetric encryption of the storage key by using the data itself. As shown in FIG. 2, the procedure mainly includes following steps.

Step 201: before uploading data from a user, the client side of the user calculates the HASH value of the data and submits the HASH value to the server side;

Step 202: the server side judges whether any of stored data in the server has the same HASH value; if yes, execute Step 203; if no, execute Step 206;

Step 203: the server side sends the data key of the data having the same HASH value in the server to the client side;

Step 204: the client side uses the unencrypted data at its own side to decrypt the data key and obtain the storage key, uses the encryption key of the user to encrypt the storage key to generate the personal key of the user and sends the personal key to the server;

Step 205: the server saves the personal key of the user and the client side does not need to actually upload the data to the server. The process will then be terminated.

Step 206: the client side uses a storage key to encrypt the data and uploads the encrypted data to the server side.

Step 207: the client side uses the encryption key of the user to encrypt the storage key to generate the personal key of the user, uses the unencrypted data to encrypt the storage key to generate the data key of the data, and then sends the HASH value of the unencrypted data, personal key and data key to the server. The process will then be terminated.

In the future, when the user wants to access the data he/she owns, the personal key is decrypted with the user's decryption key to obtain the storage key, and then the encrypted data is decrypted with the storage key to obtain the unencrypted data.

The technical scheme above ensures that duplicate data will not be stored repeatedly and, furthermore, duplicate data will not be uploaded repeatedly. Meanwhile, only the users who actually have the same unencrypted data can obtain the storage key and access the data. The storage service provider and other users cannot obtain the storage key or unencrypted data, hence, compared to the data security in the prior art, the data security is enhanced.

In one embodiment of this present invention, the client side gets the encrypted data and personal key from the server, decrypts the personal key to obtain the storage key, and decrypts encrypted data with storage key to obtain unencrypted data. This embodiment ensures that the server side can never be aware of unencrypted data or storage keys. In another embodiment, the server decrypts the personal key to obtain the storage key, decrypts encrypted data with the storage key to obtain the unencrypted data, and deletes storage key and the unencrypted data after usage.

Besides the unencrypted data, a key generated from the unencrypted data may also be used to encrypt the storage key to obtain the data key or decrypt the data key to obtain the storage key.

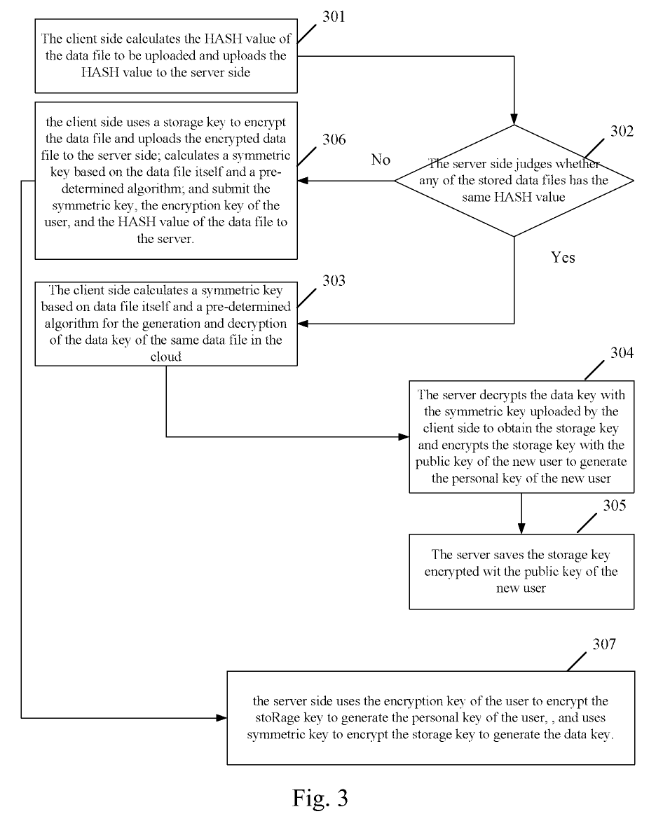

In another embodiment of the present invention, when the server side determines that duplicates of the data to be uploaded exist among the stored data, the server side will inform the client side and the client side will calculate a decryption key used for decrypting the data key to obtain the storage key, based on the data to be uploaded and a pre-determined algorithm, and then send the decryption key for the data key to the server. The server decrypts the data key with the decryption key uploaded by the client to obtain the storage key; then a key of the user is used to encrypt the storage key to generate the personal key of the user. FIG. 3 shows a practical example of the embodiment.

FIG. 3 shows a storage method provided in another embodiment of the present invention. In this embodiment, symmetric keys are calculated based on the data to be uploaded and a pre-determined algorithm for encrypting the storage key to obtain the data key or decrypting the data key to obtain the storage key. As shown in FIG. 3, the procedure mainly includes the following steps.

Step 301: before uploading new data, the client side calculates the HASH value of the data to be uploaded and submits the HASH value to the server side;

Step 302: the server side judges whether any of stored data in the server has the same HASH value with the data to be uploaded; if yes, execute Step 303, if no, execute Step 306;

Step 303: the client side calculates a symmetric key based on the data to be uploaded and a pre-determined algorithm. The symmetric key is submitted to the server and will be used for the generation and decryption of the data key;

Step 304: the server decrypts the data key with the symmetric key uploaded by the client side to obtain the storage key and encrypts the storage key with the encryption key of the user to generate the personal key of the user;

Step 305: the server saves the personal key of the user and the client side does not need to actually upload the data the process will then be terminated.

Step 306: the client side uses a storage key to encrypt the data and uploads the encrypted data to the server side; calculates a symmetric key based on the data file to be uploaded and a pre-determined algorithm; and submits the symmetric key, the encryption key of the user, and the HASH value of the data to the server.

Step 307: the server side uses the encryption key of the user to encrypt the storage key to generate the personal key of the user, and uses a symmetric key to encrypt the storage key to generate the data key. The process will then be terminated.

The technical scheme of this embodiment also ensures that duplicate data will not be stored repeatedly and duplicate data will not be uploaded repeatedly. In this embodiment, the storage service provider is able to hold the storage key for a short period, but compared to the prior art in which the storage key is saved on the server side permanently, this embodiment of the present invention provides highly enhanced security.

In an embodiment of the present invention, the symmetric key for the generation and decryption of the data key is calculated by extracting data from specific location in the data, or by calculating the HASH value of the data by using a special HASH algorithm, such as calculating HASH value of the data plus a fixed string.

In another embodiment of the present invention, there is no client on the user side, e.g., a user may upload files through web browser, in which it hard for the user side to calculate the HASH value of data to be uploaded and submits the value to the server side. Therefore, the server needs to obtain the unencrypted data temporarily and then follows the methods shown in the previous embodiments: calculates the HASH value, judges whether duplicate data exist, uses the unencrypted data to decrypt the data key and obtain the storage key, and uses a key from the user to encrypt the storage key to generate a personal key, then removes unencrypted data and storage key. Such an approach cannot reduce duplicate uploading, but can reduce duplicate storing copies of same file.

In above embodiments and other embodiments of present invention, the storage key can be a randomly-generated key, to ensure this key is brand-new and no one else knows the key.

In above embodiments, one storage key is used for both encrypting the data to be uploaded and decrypting the encrypted data to obtain unencrypted data. In another embodiment, an encryption key is used to encrypt the data to be uploaded to obtain encrypted data and a decryption key is used to decrypt the encrypted data to obtain unencrypted data, and the two keys are different. In this situation, the data key and the personal key are obtained by encrypting the decryption key.

The key used to encrypt storage key to obtain the data key and/or the key used to decrypt the data key to obtain the storage key is related to the data to be uploaded. In the above embodiments, the key may be the data to be uploaded itself, or the key is calculated based on the data to be uploaded itself and a pre-determined algorithm. Also, in one embodiment, it may be determined by the data to be uploaded itself and other data. For example, the key may be the HASH value of the combination of data to be uploaded itself and data shared by users involved. In general, the key used to decrypt the data key to obtain the storage key cannot easily be figured out without the unencrypted data. In another embodiment, the key used to encrypt the storage key to obtain data key and decrypt the data key to obtain the storage key are different. The encryption/decryption algorithm can be a symmetric one, or an asymmetric one. For example, the symmetric key of FIG. 3 can be replaced by a pair of asymmetric keys.

Any keys in the above embodiments, including keys for encrypting/decrypting data, keys for generating or decrypting the personal key and data key, can be asymmetric public/private keys, or a symmetric key.

In above embodiments and other embodiments of present invention, each encryption or decryption can be implemented by either the server side or the client side, i.e. if one of steps says the server side encrypts/decrypts data (not only means the data to be uploaded, but also includes the storage key or other keys), an alternative embodiment is that client side does the same encryption/decryption, and vice versa. The data flow between the server side and the client side will be adjusted accordingly if necessary. For example, an alternative of step 206 may be “the client side uploads the unencrypted data to the server side and the server side uses a storage key to encrypt the data”. An alternative of step 303 & 304 may be “Step 303: the client side calculates a symmetric key based on the data to be uploaded and a pre-determined algorithm; Step 304: the client decrypts the data key with the symmetric key calculated to obtain the storage key and encrypts the storage key with the encryption key of the user to generate the personal key of the user, sends personal key to the server.” If an embodiment or alternative embodiment includes server encrypting/decrypting data or a storage key, it would be better that the server removes unencrypted data and/or the storage key before the end of the process. The security will be better when all of encryptions/decryptions of data or storage key are implemented on the client side, because the server is unable to obtain unencrypted data.

In an embodiment of present invention, User A has an encryption key ekA and a corresponding decryption key dkA, User B has an encryption key ekB and a corresponding decryption key dkB. When User A uploading data X which has not been stored, the method comprises of:

Step 401: the client at User A's side calculates the data X's HASH value hX and submits the HASH value hX to the server side;

Step 402: the server searches HASH values of all stored data, and determines that there are not any data having the same HASH value with the HASH value hX;

Step 403: the client uses a storage encryption key ekS to encrypt the data X to obtain encrypted data Y, and uploads the data Y to the server;

Step 404: the client calculates an encryption key ekX based on the data X and a pre-determined algorithm, uses the key ekX to encrypt the storage decryption key dkS which is the corresponding decryption key of the key ekS, to obtain a data key kX, and submits the key kX to the server;

Step 405: the client uses the key ekA to encrypt the key dkS to obtain User A's personal key kA, and submits the key kA to the server;

Step 406: the server saves the HASH value hX, the data Y, the key kX and the key kA.

In an embodiment of the present invention, step 403 to step 405 may be as follows:

Step 403: the client uploads the data X to the server side;

Step 404: the server uses a storage encryption key ekS to encrypt the data X to obtain encrypted data Y, calculates an encryption key ekX based on the data X and a pre-determined algorithm, uses the key ekX to encrypt the storage decryption key dkS which is the corresponding decryption key of the key ekS to obtain data key kX, and uses the key ekA to encrypt the key dkS to obtain User A's personal key kA;

Step 405: the server deletes the data X and the key dkS.

When User B uploading data X which has already been uploaded by user A, the method comprises of:

Step 501: the client at User B's side calculates the data X's HASH value hX and submits HASH value hX to the server;

Step 502: the server searches HASH values of all stored data, finds that there already exists data X with the HASH value hX;

Step 503: the server sends the data X's data key kX to the client side;

Step 504: based on the data X in the client and pre-determined algorithm, the client calculates the decryption key dkX, uses the key dkX to decrypt the key kX to obtain the key dkS, uses User B's key ekB to encrypt the key dkS to obtain User B's personal key kB, and submits the key kB to the server;

Step 505: the server side saves the key kB.

When User A accessing the data X further, the method comprises of:

Step 601: the server sends the encrypted data Y and User A's personal key kA to the client at User A's side;

Step 602: the client uses User A's decryption key dkA to decrypt the key kA to obtain the key dkS;

Step 603: the client uses the key dkS to decrypt the data Y to obtain unencrypted data X.

In this embodiment, the key ekA and the key dkA may be the same or different, the key ekB and the key dkB may be the same or different, the key ekS and the key dkS may be the same or different, the key ekX and the key dkX may be the same or different. The key eKS and the key dkS can be newly-generated random key.

In one embodiment, the keys ekA, dkA, ekB and dkB may be stored at the client side or the server side. In one embodiment, the ekA and ekB are public keys, stored in both the client side and server side, and dkA and dkB are private keys, stored in the client side.

An embodiment of the present invention also provides a storage system, includes a processor coupled to a memory storing instructions for execution by the processor, and further includes:

First Encryption Module, used for encrypting data with a storage key and encrypting the storage key with two different encryption methods to generate a personal key and a data key respectively, wherein a key of a user who owns the data can decrypt the personal key to obtain the storage key and the unencrypted data can decrypt the data key to obtain the storage key;

Storage Module, used for saving the encrypted data, personal key and data key;

Judgment Module, used for judging, before storing the data from the user, whether a duplicate of the other data can be found in stored data; informing First Encryption Module if there is not duplicate in the stored data; or informing Key Authorization Module; Key Authorization Module, used for decrypting, when the Judgment Module returns a positive judgment, the data key of the data to obtain the storage key, and encrypting the storage key with a key of the user to generate the personal key of the user.

An embodiment of the present invention includes a server, wherein the server includes First Encryption Module, Storage Module, Judgment Module and Key Authorization Module.

In another embodiment of the present invention, the system further includes a client, wherein the client includes a processor coupled to a memory storing instructions for execution by the processor, and further includes:

Decryption Module, used for receiving the data key from the server and decrypting the data key with the unencrypted data to obtain the storage key;

Second Encryption Module, used for encrypting the storage key with a key of the user to generate the personal key of the user and sending the personal key of the user to the server; and

At this situation, the Key Authorization Module on the server side includes:

Transmitter Sub-Module, used for sending the data key to the client when the judgment result from the Judgment Module is positive; and

Receiver Sub-Module, used for receiving the personal key of the new user from the client and sending the personal key to the Storage Module for storage.

In another embodiment, the server side further includes a Remove Module, used for deleting unencrypted data and storage key in real-time after the usage.

In another embodiment, the First Encryption Module is located on the client side instead.

In another embodiment, the First Encryption Module is further used for generating a random storage key before using the storage key to encrypt the data.

In another embodiment of the present invention, the client includes:

Key Generation Module, used for calculating the decryption key of the data key based on the data itself and the pre-determined algorithm and sending the decryption key to the server;

and the Key Authorization Module on the server side includes:

Receiver Sub-Module, used for receiving from the client the decryption key of the data key, which is calculated based on the data itself and the pre-determined algorithm;

Encryption/Decryption Sub-Module, used for decrypting the data key with the decryption key uploaded by the client to obtain the storage key and encrypting the storage key with a key from the new user to generate the personal key of the new user.

In another embodiment of the present invention, the above client side may include:

HASH Value Calculation Module, used for calculating the HASH value of the data from the new user and uploading the HASH value to the server so that the server can judge whether any of the data stored already has an identical HASH value.

The above Storage Module is further used for storing HASH value of stored data.

The structure schematics of the storage system described in embodiments of the present invention are explained further below by using two detailed embodiments.

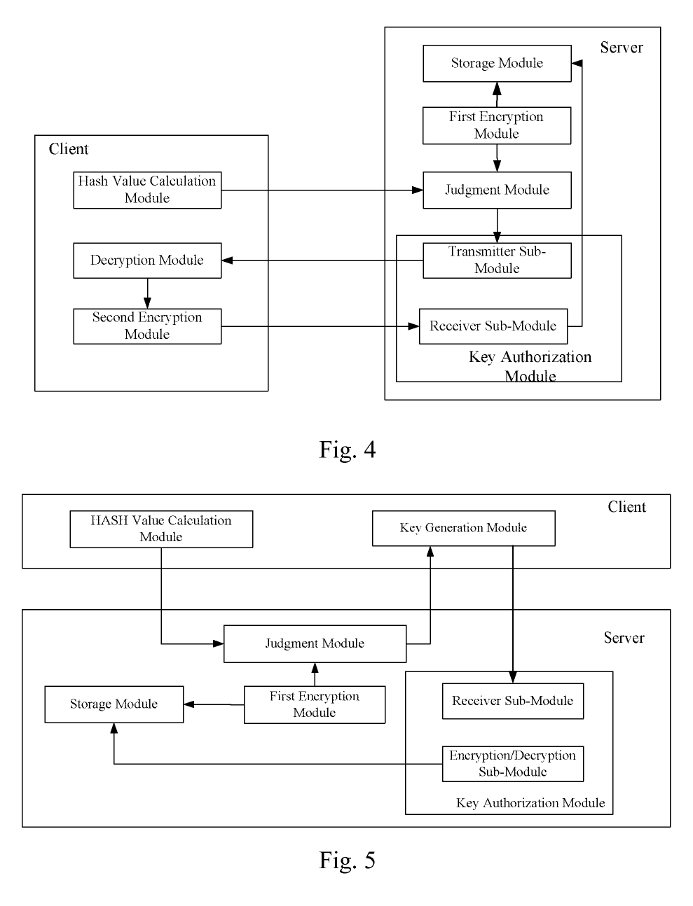

FIG. 4 is another schematic diagram illustrating the structure of the storage system provided in the embodiment of the present invention. As shown in FIG. 4, the system includes a client side and a server side, wherein the client side includes HASH Value Calculation Module, Decryption Module and Second Encryption Module; and the server side includes First Encryption Module, Storage Module, Judgment Module and Key Authorization Module, wherein, the Key Authorization Module includes Transmitter Sub-Module and Receiver Sub-Module.

The specific usage and functions of the modules and sub-modules are given in the description of previous embodiments.

FIG. 5 is another schematic diagram illustrating the structure of the storage system provided in the embodiment of the present invention. As shown in FIG. 5, the system includes a client side and a server side, wherein the client side includes HASH Value Calculation Module and Key Generation Module; and the server side includes First Encryption Module, Storage Module, Judgment Module and Key Authorization Module, and wherein, the Key Authorization Module includes of Receiver Sub-Module and Encryption/Decryption Sub-Module.

The specific usage and functions of the modules and sub-modules are given in the description of previous embodiments.

The specific usage and functions of the modules and sub-modules are given in the description of previous embodiments.

In another embodiment of the present invention, there is no client on the user side, therefore all the modules in the embodiments above may be located on the server side.

An embodiment of the present invention also provides a storage system, comprising of a processor coupled to a memory storing instructions for execution by the processor, and further comprising:

A First Module, used for encrypting data with a storage key;

A Second Module, used for encrypting the storage key with two different encryption methods to generate a personal key and a data key respectively, wherein a key from the user who owns the data can decrypt the personal key to obtain the storage key and the unencrypted data can decrypt the data key to obtain the storage key;

A Third Module, used for saving the encrypted data, personal key and data key;

A Fourth Module, used for decrypting, when data to be uploaded from a user is same with any of the stored data in the server, the data key of the data in the server to obtain the storage key, and encrypting the storage key with a key from the user to generate the personal key of the user.

In one embodiment, the First Module, the Second Module, and the Fourth Module are located in the client; and the Third Module is located in the server. And the client further includes:

The Fifth Module, used for receiving, when the user accesses the data owned by the user, the personal key of the user, and decrypting the personal key with the key of the user to obtain the storage key and decrypting the encrypted data with the storage key to obtain the unencrypted data.

In another embodiment, the First Module is located in the client; and the Second Module, Third Module and Fourth Module are located in the server. And the client further includes:

The Sixth Module, used for calculating a symmetric key based on the unencrypted data and a pre-determined algorithm, submits the symmetric key to the server and is used for the generation and decryption of the data key, and submits the key of the user to the server;

Wherein, the Second Module used for encrypting the storage key with the key of the user and the symmetric key to generate a personal key and a data key respectively.

Wherein, the Fourth Module includes

A First Sub-Module, used for receiving the symmetric key from the client;

A Second Sub-Module, used for decrypting the data key with the symmetric key uploaded by the client side to obtain the storage key and encrypting the storage key with the key of the user to generate the personal key of the user;

In another embodiment, the First Module, Second Module, Third Module and Fourth Module are located in the server.

In another embodiment, the server further includes:

A Six Module, used for determining the data to be uploaded from the user is the same as any of the data already stored in the server.

The present invention also provides a storage apparatus, which is the server described in the above embodiment, or the client described in the above embodiments.

Those skilled in the art know that those storage method, server, and client can be set in one single machine (PC, Server), or distributed system, or system with other structure.

The above embodiments of a storage method, system, server and client are just illustrated examples; any of the features in different embodiments can be reorganized to obtain new embodiments, which are still within the scope of the present invention.

The foregoing are only preferred embodiments of the present invention and is not for use in limiting the protection scope thereof Any modification, equivalent replacement and improvement made without departing from the spirit and principle of the present invention should be included within the protection scope thereof.

1. A storage method, wherein User A has an encryption key ekA and a corresponding decryption key dkA, comprising:
encrypting data X from User A with a storage encryption key ekS to obtain encrypted data Y;
encrypting dkS which is the corresponding decryption key of ekS with ekA to obtain User A's personal key kA;
encrypting dkS with a encryption key ekX related to X to obtain X's data key kX;
storing Y, kA and kX;
wherein, when User B who has an encryption key ekB and a corresponding decryption key dkB willing to store data X, the method further comprises:
calculating dkX which is the corresponding decryption key of ekX based on X;
decrypting kX with dkX to obtain dkS;
encrypting dkS with ekB to obtain User B's person key kB;
storing kB.

2. A method according to claim 1, further comprising:
decrypting, when user A accesses X, kA with dkA to obtain dkS, and decrypting Y with dkS to obtain X.

3. A method according to claim 1, further comprising:
determining, when user B willing to store data, whether the data to be stored is the same as any of stored data.

4. A method according to claim 3, wherein determining whether the data to be stored is the same as any of stored data comprises:
determining any of data stored has a HASH value identical to the HASH value of the data to be stored.

5. A method according to claim 1, wherein there exists a client cA in User A's side and a server, and cA encrypts X with ekS to obtain Y, calculates ekX based on X and a pre-determined algorithm, encrypts dkS with ekA to obtain kA, encrypts dkS with ekX to obtain kX, and sends Y, kA and kX to the server for storage.

6. A method according to claim 5, wherein ekS is a random key generated by cA.

7. A method according to claim 5, wherein there exist a client cB in User B's side, and cB receives kX from the sever, calculates dkXe, and decrypts kX with the dkX to obtain dkS; encrypts dkS with ekB to obtain kB, and send kB to the server for storage.

8. A method according to claim 7, further comprising:
calculating, when user B is willing to store data, by cB, the HASH value hX of X;
submitting, by cB, hX to the server;
comparing, by the server, hX with the HASH values of existing data to determine whether X is same with any of the stored data

9. A method according to claim 5, further comprising:
receiving, when user A accesses X, by cA, Y and kA from the server,
decrypting, by cA, kA with dkA to obtain dkS; and
decrypting, by cA, Y with dKS to obtain X.

10. A method according to claim 1, there exists a client cA in user A's side and a server, and the server receives X and ekA from cA, the server encrypts X with ekS to obtain Y; calculates ekX based on X and a pre-determined algorithm, encrypts dkS with ekA to obtain kA, encrypts dkS with ekX to obtain kX; stores Y, kA and kX; and delete X and dkS.

11. A method according to claim 10, wherein cA is a browser.

12. A method according to claim 1, wherein, when user A accesses X, the server decrypts kA with dKA to obtain dkS, decrypts Y with dkS to obtain X, deletes dkS, and deletes X after usage.

13. A method according to claim 1, there exists a client cB in user B's side, the server receives X from cB, calculates dkX based on X and a pre-determined algorithm, decrypts kX with dkX to obtain dkS, encrypts dkS with ekB to obtain kB, and deletes X

14. A method according to claim 1, wherein the dkX cannot be calculated without X.

15. A method according to claim 1, wherein the dkX is calculated by extracting data from specific location in X, or by calculating the HASH value of X and a data which is fixed or shared by both user A and user B.

16. A method according to claim 1, wherein, dkS and ekS, ekX and dkX, or ekA and dkA are symmetric keys or an encryption key and decryption key of asymmetric keys respectively.

17. A storage server, comprising a processor coupled to a memory storing instructions for execution by the processor, and further comprising:
First Encryption Module, adapted to encrypt data with a storage key and encrypt the storage key with two different encryption methods to generate a personal key and a data key respectively, wherein the personal key can be decrypted with a key of a user who owns the data to obtain the storage key, and the data key can be decrypted with a key related to unencrypted data to obtain the storage key;
Storage Module, adapted to save the encrypted data, personal key and data key;
Key Authorization Module, adapted to decrypt, when willing to store the same data from another user, the data key of the data to obtain the storage key, and encrypt the storage key with a key of the another user to generate the personal key of the another user.
Remove Module, adapted to delete unencrypted data and storage key.

18. A storage server according to claim 17, further comprising:
Judgment Module, adapted to judge, before storing data from the another user, whether a duplicate of the data to be stored from the another user can be found in stored data; inform First Encryption Module if there is not duplicate in the stored data; or inform Key Authorization Module.

19. A storage client, comprising a processor coupled to a memory storing instructions for execution by the processor, and further comprising:
First Module, adapted to encrypt data X with a storage encryption key ekS to obtain encrypted data Y;
Second Module, adapted to encrypt dkS which is the corresponding decryption key of ekS with an encryption key ekA of User A to obtain User A's personal key kA; and encrypt dkS with a encryption key ekX related to X to obtain X's data key kX
Third Module, adapted to send Y, kA and kX to a server for storage; and
the client further comprising:
Fourth Module, adapted to calculate, when User B who has an encryption key ekB and a corresponding decryption key dkB willing to store data X, dkX which is the corresponding decryption key of ekX based on X; decrypt kX received from the server with dkX to obtain dkS, and encrypt kX with ekB to obtain kB;
Fifth Module, adapted to send kB to the server for storage.

20. A storage client according to claim 19, further comprising:
Sixth Module, adapted to decrypt, when accesses X, kA received from the server with dkA to obtain dkS, and decrypt Y with dkS to obtain X.
